(19) United States
(12) Patent Application Publication
(10) Pub. No.: US 2023/0386209 A1
(43) Pub. Date: Nov. 30, 2023

(54) PROCESSING DEVICE, PROCESSING METHOD, AND NON-TRANSITORY STORAGE MEDIUM

(71) Applicant: NEC Corporation, Tokyo (JP)

(72) Inventors: Jun UCHIMURA, Tokyo (JP); Yuji Tahara, Tokyo (JP); Rina Tomita, Tokyo (JP); Yasuyo Kazo, Tokyo (JP)

(73) Assignee: NEC Corporation, Tokyo (JP)

(21) Appl. No.: 18/232,760

(22) Filed: Aug. 10, 2023

Related U.S. Application Data
(63) Continuation of application No. 17/771,230, filed on Apr. 22, 2022.

(30) Foreign Application Priority Data
Nov. 5, 2019 (JP) 2019-200590

(51) Int. Cl. G06V 20/50; G06T 7/90; G06V 10/22; G06Q 30/018; G06T 7/60

(52) U.S. Cl. CPC G06V 20/50; G06T 7/90; G06V 10/22; G06Q 30/018; G06T 7/60; G06T 2207/10024; G08B 13/196

(57) ABSTRACT

The present invention provides a processing apparatus (10) including an acquisition unit (11) acquiring a captured image including a managed object related to a store, a foreign object region detection unit (12) detecting a foreign object region being a region in which a foreign object exists in the managed object included in the captured image, and a warning unit (13) executing warning processing depending on the size of the foreign object region.

### CROSS-REFERENCE TO RELATED APPLICATIONS

This application is a Continuation application of U.S. patent application Ser. No. 17/771,230 filed on Apr. 22, 2022, which is a National Stage Entry of PCT/JP2020/040581 filed on Oct. 29, 2020, which claims priority from Japanese Patent Application 2019-200590 filed on Nov. 5, 2019, the contents of all of which are incorporated herein by reference, in their entirety.

### TECHNICAL FIELD

The present invention relates to a processing apparatus, a processing method, and a program.

### BACKGROUND ART

Patent Document 1 discloses an apparatus storing a state of a shelf after products are organized by a clerk (a reference state), detecting a change by comparing a state of the shelf after a customer takes an action on the shelf with the reference state, and notifying that organization of the products on the shelf is required, depending on the detection result.

### RELATED DOCUMENT

### Patent Document

Patent Document 1: Japanese Patent Application Publication No. 2016-81364

### DISCLOSURE OF THE INVENTION

### Technical Problem

From a viewpoint of improving sales, ensuring security, and the like, it is desired to detect a foreign object existing in a store in an early stage and remove the foreign object. In particular, a clerk may not exist or the number of clerks may be small in an unmanned store or a manpower-reduced store being under study in recent years, and therefore inconveniences such as a delay in foreign object detection and a failure to notice existence of a foreign object may occur. Note that examples of a foreign object include an object other than a product, the object being placed on a product shelf, a different product placed in a region for displaying a product A on a product shelf, and objects irrelevant to store operation, the objects being placed on a floor, a table, a copying machine, and a counter in a store and in a parking lot of the store.

An object of the present invention is to provide a technology for detecting a foreign object existing in a managed object related to a store.

### Solution to Problem

The present invention provides a processing apparatus including:
an acquisition means for acquiring a captured image including a managed object related to a store;
a foreign object region detection means for detecting a foreign object region being a region in which a foreign object exists in the managed object included in the captured image; and
a warning means for executing warning processing depending on a size of the foreign object region.

Further, the present invention provides a processing method including, by a computer:
acquiring a captured image including a managed object related to a store;
detecting a foreign object region being a region in which a foreign object exists in the managed object included in the captured image; and
executing warning processing depending on a size of the foreign object region.

Further, the present invention provides a program causing a computer to function as:
an acquisition means for acquiring a captured image including a managed object related to a store;
a foreign object region detection means for detecting a foreign object region being a region in which a foreign object exists in the managed object included in the captured image; and
a warning means for executing warning processing depending on a size of the foreign object region.

### Advantageous Effects of Invention

The present invention enables detection of a foreign object existing in a managed object related to a store.

### BRIEF DESCRIPTION OF THE DRAWINGS

FIG. 1 is a diagram illustrating an example of a hardware configuration of a processing apparatus according to the present example embodiment.

FIG. 2 is an example of a functional block diagram of the processing apparatus according to the present example embodiment.

FIG. 3 is a diagram schematically illustrating an example of information processed by the processing apparatus according to the present example embodiment.

FIG. 4 is a diagram schematically illustrating an example of information processed by the processing apparatus according to the present example embodiment.

FIG. 5 is a diagram schematically illustrating an example of information processed by the processing apparatus according to the present example embodiment.

FIG. 6 is a diagram schematically illustrating an example of information processed by the processing apparatus according to the present example embodiment.

FIG. 7 is a diagram schematically illustrating an example of information processed by the processing apparatus according to the present example embodiment.

FIG. 8 is a diagram schematically illustrating an example of information processed by the processing apparatus according to the present example embodiment.

FIG. 9 is a flowchart illustrating an example of a flow of processing in the processing apparatus according to the present example embodiment.

FIG. 10 is a flowchart illustrating an example of a flow of processing in the processing apparatus according to the present example embodiment.

FIG. 11 is a flowchart illustrating an example of a flow of processing in a processing apparatus according to the present example embodiment.

FIG. 12 is a diagram schematically illustrating an example of information processed by the processing apparatus according to the present example embodiment.

### DESCRIPTION OF EMBODIMENTS

### First Example Embodiment

First, an outline of a processing apparatus according to the present example embodiment is described. The processing apparatus acquires a captured image including a managed object related to a store. A managed object is an object in which detection/removal of a foreign object is desired, examples of which including but not limited to a product display shelf, a floor, a table, a copying machine, a counter, and a parking lot. Then, the processing apparatus detects a foreign object region being a region in which a foreign object exists in the managed object included in the captured image and executes warning processing depending on the size of the detected foreign object region.

Thus, the processing apparatus that can detect a foreign object region in a managed object included in a captured image enables automatic detection of a foreign object existing in the managed object by image analysis. Then, the processing apparatus can perform warning processing depending on the size of the detected foreign object region and therefore can avoid a warning against a negligibly small-sized foreign object not affecting store operation and an erroneous warning based on noise of image data not being a foreign object to begin with.

Next, an example of a hardware configuration of the processing apparatus is described. A functional unit included in the processing apparatus according to the present example embodiment is implemented by any combination of hardware and software centering on a central processing unit (CPU), a memory, a program loaded into the memory, a storage unit storing the program [capable of storing not only a program previously stored in a shipping stage of the apparatus but also a program downloaded from a storage medium such as a compact disc (CD) or from a server on the Internet], such as a hard disk, and a network connection interface in any computer. Then, it should be understood by a person skilled in the art that various modifications to the implementation method and the apparatus can be made.

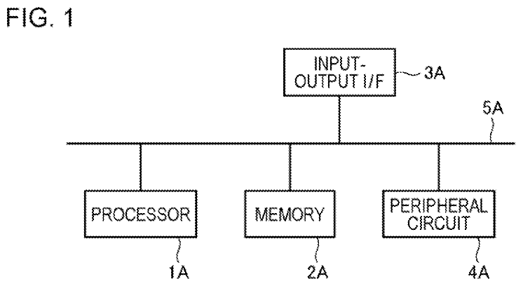

FIG. 1 is a block diagram illustrating a hardware configuration of the processing apparatus according to the present example embodiment. As illustrated in FIG. 1, the processing apparatus includes a processor 1A, a memory 2A, an input-output interface 3A, a peripheral circuit 4A, and a bus 5A. The peripheral circuit 4A includes various modules. Note that the peripheral circuit 4A may not be included. Note that the processing apparatus may be configured with a physically and/or logically integrated single apparatus or may be configured with a plurality of physically and/or logically separated apparatuses. When the processing apparatus is configured with a plurality of physically and/or logically separated apparatuses, each of the plurality of apparatuses may include the aforementioned hardware configuration.

The bus 5A is a data transmission channel for the processor 1A, the memory 2A, the peripheral circuit 4A, and the input-output interface 3A to transmit and receive data to and from one another. Examples of the processor 1A include arithmetic processing units such as a CPU and a graphics processing unit (GPU). Examples of the memory 2A include memories such as a random access memory (RAM) and a read only memory (ROM). The input-output interface 3A includes an interface for acquiring information from an input apparatus, an external apparatus, an external server, an external sensor, a camera, and the like, and an interface for outputting information to an output apparatus, the external apparatus, the external server, and the like. Examples of the input apparatus include a keyboard, a mouse, a microphone, a touch panel, a physical button, and a camera. Examples of the output apparatus include a display, a speaker, a printer, and a mailer. The processor 1A can give an instruction to each module and perform an operation, based on the operation result by the module.

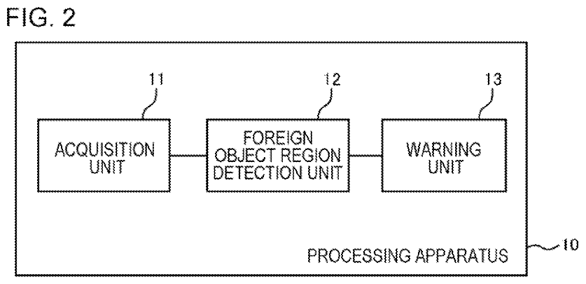

Next, a functional configuration of the processing apparatus is described. FIG. 2 illustrates an example of a functional block diagram of the processing apparatus 10. As illustrated, the processing apparatus 10 includes an acquisition unit 11, a foreign object region detection unit 12, and a warning unit 13.

The acquisition unit 11 acquires a captured image including a managed object related to a store. The managed object is an object in which detection/removal of a foreign object is desired and includes at least one of a product display shelf, a floor, a table, a copying machine, a counter, and a parking lot. Note that the managed object may include another object.

The acquisition unit 11 acquires a captured image generated by a camera capturing an image of a managed object. Note that the acquisition unit 11 may acquire a captured image acquired by performing editing processing on the captured image generated by the camera. The editing processing may be performed as needed according to the type of camera being used, the direction of the installed camera, and the like, example of which including but not limited to projective transformation and processing of two-dimensionally developing an image captured by a fisheye camera. The acquisition unit 11 may perform the editing. In addition, an external apparatus different from the processing apparatus 10 may perform the editing, and the acquisition unit 11 may acquire an edited captured image.

The camera is fixed at a predetermined position in such a way as to capture an image of a managed object. Note that the direction of the camera may also be fixed. The camera may continuously capture a dynamic image or may capture a static image at a predetermined timing. Further, a plurality of cameras may be installed, and the acquisition unit 11 may acquire a captured image generated by each of the plurality of cameras; or one camera may be installed, and the acquisition unit 11 may acquire a captured image generated by the camera. It is assumed in the present example embodiment that a plurality of cameras are installed and that the acquisition unit 11 acquires a captured image generated by each of the plurality of cameras.

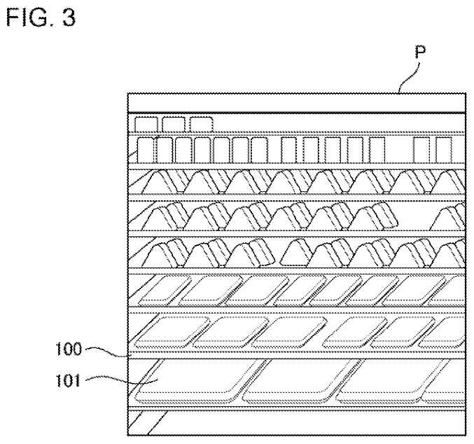

FIG. 3 schematically illustrates an example of a captured image P. A managed object in the example is a product display shelf. A situation of a product 101 being displayed on a shelf board 100 is illustrated.

Returning to FIG. 2, the foreign object region detection unit 12 detects a foreign object region in the managed object included in the captured image. A foreign object region is a region in which a foreign object is estimated to exist.

The foreign object region detection unit 12 detects a region in a color different from a specified color in the managed object included in the captured image as a foreign object region. Note that when detecting a region in a color different from the specified color, the foreign object region detection unit 12 may determine whether an approved object exists in the region and may detect a region in a color different from the specified color, the approved object not being determined to exist in the region, as a foreign object region. Then, the foreign object region detection unit 12 may not detect a region being a region in a color different from the specified color, the approved object being determined to exist in the region, as a foreign object region.

The specified color is set for each managed object. For example, when a managed object is a product display shelf, the specified color is the color of a shelf board on which a product and an object are placed. When a managed object is a floor, the specified color is the color of the floor. When a managed object is a table, the specified color is the color of a stand on which an object on the table is placed. When a managed object is a copying machine, the specified color is the color of the upper surface of the copying machine on which an object may be placed. When a managed object is a parking lot, the specified color is the color of the ground in the parking lot.

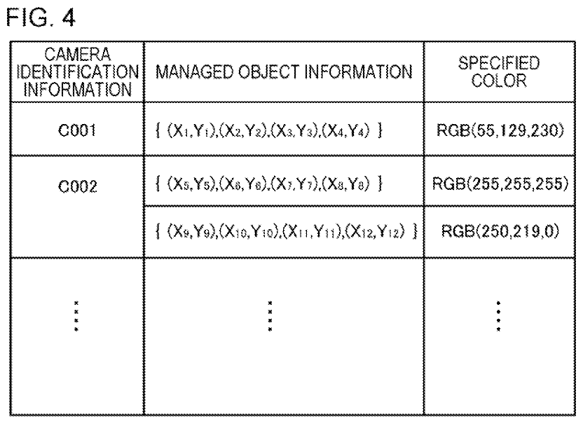

For example, the processing apparatus 10 may store information indicating a region in which a managed object exists in a captured image for each camera and information indicating a specified color, as illustrated in FIG. 4. Then, based on the information, the foreign object region detection unit 12 may determine a managed object in a captured image generated by each camera and determine a region in a color different from the specified color in the determined managed object. In the example illustrated in FIG. 4, camera identification information for identifying each camera, managed object information indicating a region in which a managed object exists in a captured image, and a specified color of each managed object are associated with each other. While a region in which a managed object exists is indicated by determining a quadrilateral region by using coordinates in a two-dimensional coordinate system set to a captured image in the illustrated example of managed object information, the aforementioned technique is strictly an example and does not limit the technique for indicating such a region. As illustrated, one managed object may exist in one captured image, or a plurality of managed objects may exist in one captured image. It depends on how the camera is installed as to which case applies.

One color may be specified as a specified color of a managed object in a pinpoint manner, or a certain range of colors may be specified.

An approved object is an object approved to exist in a managed object. For example, when a managed object is a product display shelf, the approved object is a product. Note that when a managed object is a product display shelf, the approved object may be set for each display area. In this case, the approved object is a product displayed in each display area. Specifically, a product A displayed in a display area A is an approved object in the display area A but is not an approved object in a display area B.

When a managed object is a floor, the approved objects include a delivered article temporarily placed on the floor. When a managed object is a table, the approved objects include a product and belongings of a customer. When a managed object is a copying machine, the approved objects include belongings of a customer and copy paper. When a managed object is a parking lot, the approved objects include an automobile and a motorcycle.

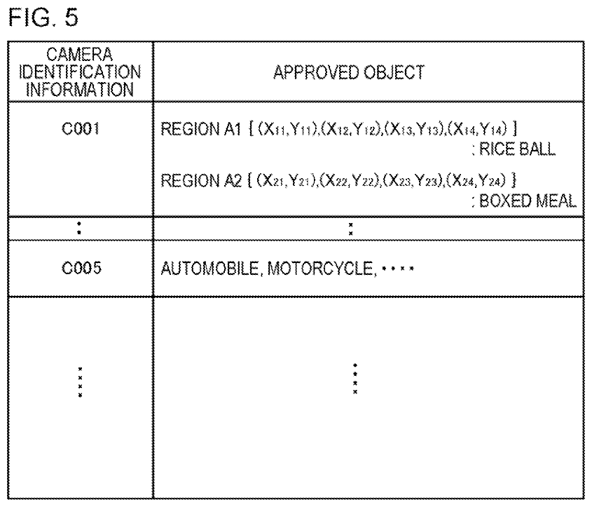

For example, the processing apparatus 10 may store information indicating an approved object for each camera, as illustrated in FIG. 5. Then, based on the information, the foreign object region detection unit 12 may recognize an approved object in a managed object included in a captured image generated by each camera. Note that when one managed object is divided into a plurality of regions (a plurality of display areas) and an approved object is specified for each region as is the case with a product display shelf, a region is specified in a captured image, and an approved object for each specified region may be recorded in association with the specified region, as indicated in the illustrated example of camera identification information “C001.”

A technique for determining whether an approved object exists in a region in a color different from a specified color is not particularly limited, and any image analysis processing may be used. For example, an estimation model estimating an article type (such as a rice ball, a boxed meal, an automobile, a motorcycle, or belongings of a customer) from an image by machine learning may be previously generated. Then, by inputting an image of a region in a color different from a specified color to the estimation model, the foreign object region detection unit 12 may estimate an article type existing in the region and determine whether an approved object exists in the region in a color different from the specified color, based on the estimation result.

In addition, when a managed object is a product display shelf, whether an approved object exists in a region in a color different from a specified color may be determined by matching processing (such as template matching) between an image (template image) of an approved object preregistered in the processing apparatus 10 for each display area and an image of the region in a color different from the specified color.

Returning to FIG. 2, the warning unit 13 executes warning processing depending on the size of a foreign object region detected by the foreign object region detection unit 12. Specifically, when the size of a foreign object region detected by the foreign object region detection unit 12 is equal to or greater than a reference value, the warning unit 13 executes the warning processing. Note that the warning unit 13 determines whether the size is equal to or greater than the reference value for each block foreign object region. Specifically, when a plurality of foreign object regions apart from each other are detected, the warning unit 13 determines whether the size is equal to or greater than the reference value for each foreign object region.

For example, the reference value may be indicated by the number of pixels but is not limited thereto.

Note that the reference value may be the same value for every captured image across the board. However, for the following reason, a reference value may be set for each camera generating a captured image or further for each region in the captured image.

The size of a foreign object that needs to be removed may vary by managed object. For example, in a case of a product display shelf, a relatively small foreign object is desirably removed in order to maintain cleanliness at a high level. On the other hand, in a case of a parking lot, a floor, or the like, a required level of cleanliness is lower compared with the case of a product display shelf. Therefore, it may be permitted to leave a relatively small foreign object as it is in order to be balanced with a workload of a worker. Further, even in a product display shelf, a required level of cleanliness may vary by the type of displayed product (such as food, a miscellaneous article, or a book). Thus, the size of a foreign object that needs to be removed may vary even in the same managed object.

Further, the size of a captured image may vary by the direction of the camera, the distance between the camera and a subject, and the like even in the same foreign object.

By setting a reference value for each camera generating a captured image or further for each region in the captured image, unnecessary warning processing can be avoided, and only suitable warning processing can be performed.

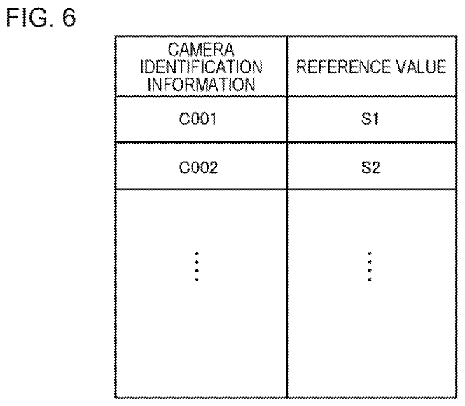

For example, the processing apparatus 10 may store information for setting a reference value for each camera, as illustrated in FIG. 6. Then, the warning unit 13 may determine a reference value, based on a camera generating a captured image including a detected foreign object region, and determine whether the size of the detected foreign object region is equal to or greater than the determined reference value.

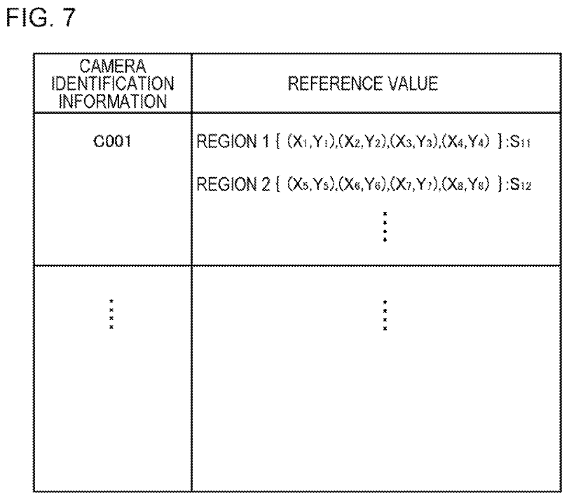

Further, the processing apparatus 10 may store information for setting a reference value for each position in a captured image, as illustrated in FIG. 7. Then, the warning unit 13 may determine a reference value, based on the position of a detected foreign object region in a captured image, and determine whether the size of the detected foreign object region is equal to or greater than the determined reference value.

The warning processing may be processing of notifying detection of a foreign object to a predetermined user by real-time processing in response to the detection by the foreign object region detection unit 12. In addition, the warning processing may be processing of accumulating information indicating a foreign object region with a size equal to or greater than a reference value and notifying information accumulated up to that point to a predetermined user (for example, transmitting predetermined information to a predetermined terminal apparatus) at a predetermined timing (for example, every hour or a timing when a browsing input from a user is performed). Notification to a user may be output of information through an output apparatus such as a display, a projector, or a speaker, transmission of information through a mailer or the like, display of information on an application or a web page, lighting of a warning lamp, or the like.

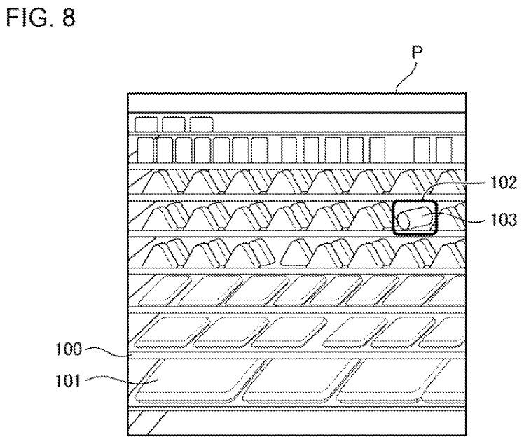

Information output by the notification processing to a user may include a captured image in which a foreign object region with a size equal to or greater than a reference value is detected. Furthermore, information for highlighting a foreign object region with a size equal to or greater than the reference value by a border or the like may also be included. FIG. 8 illustrates an example. In the illustrated example, a detected foreign object region 103 with a size equal to or greater than a reference value is highlighted by being enclosed by a border 102 in a captured image indicating a product display shelf (managed object).

Further, in addition to a captured image in which a foreign object region is detected, a captured image generated before generation of the captured image (such as an immediately preceding frame image or a frame image preceding by several frames) by a camera generating the captured image may be output together. Thus, comparison between a state in which a foreign object exists and a state in which a foreign object does not exist is facilitated.

Further, information output in the notification processing to a user may include information indicating an instruction to an operator (such as removal of a foreign object or notification to a predetermined user).

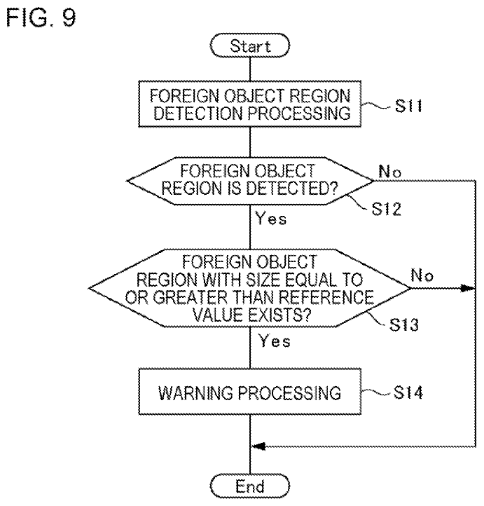

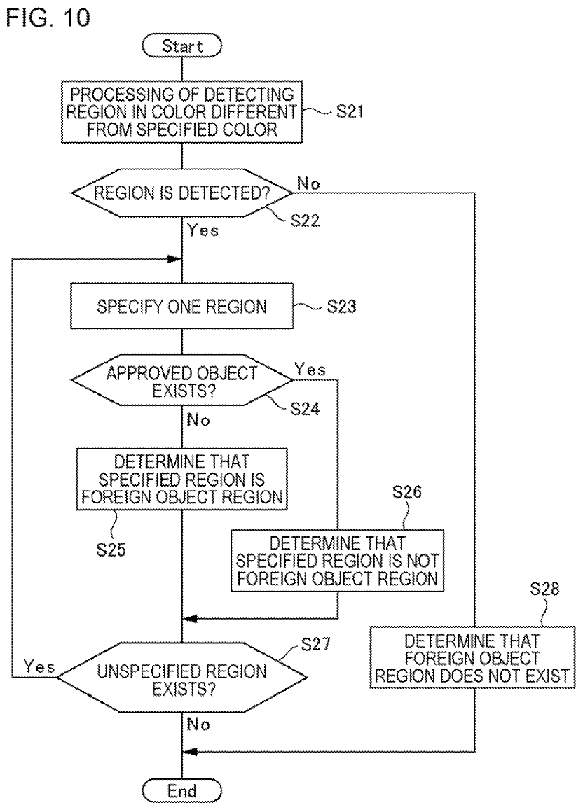

Next, an example of a flow of processing in the processing apparatus 10 is described by using flowcharts in FIG. 9 and FIG. 10.

When the acquisition unit 11 acquires a captured image, processing illustrated in FIG. 9 is executed. First, the foreign object region detection unit 12 performs processing of detecting a foreign object region being a region in which a foreign object exists in a managed object included in the captured image (S11).

FIG. 10 illustrates an example of a flow of the processing of detecting a foreign object region in S1. First, the foreign object region detection unit 12 detects a region in a color different from a specified color in the managed object included in the captured image (S21). For example, based on the information illustrated in FIG. 4 and information for identifying a camera generating the acquired captured image, the foreign object region detection unit 12 determines a managed object in the captured image and determines a specified color of the managed object. Then, the foreign object region detection unit 12 detects a region in a color different from the determined specified color in the determined managed object.

When a region in a color different from the specified color is not detected (No in S22), the foreign object region detection unit 12 determines that a foreign object region does not exist (S28).

On the other hand, when a region in a color different from the specified color is detected (Yes in S22), the foreign object region detection unit 12 divides the detected region into block regions and specifies one region (S23). Then, the foreign object region detection unit 12 determines whether an approved object exists in the specified region (S24). For example, the foreign object region detection unit 12 determines an approved object related to the specified region, based on the information illustrated in FIG. 5, the information for identifying the camera generating the acquired captured image, and the position of the specified region in the captured image. Then, the foreign object region detection unit 12 determines whether the approved object exists in the specified region by using a technique using the aforementioned estimation model, template matching, or the like.

When determining that an approved object exists (Yes in S24), the foreign object region detection unit 12 determines that the specified region is not a foreign object region (S26). On the other hand, when determining that an approved object does not exist (No in S24), the foreign object region detection unit 12 determines that the specified region is a foreign object region (S25).

Then, when a region not being specified in S23 remains (Yes in S27), the foreign object region detection unit 12 returns to S23 and repeats similar processing.

Returning to FIG. 9, when a foreign object region is not detected in the processing in S11 (No in S12), the processing apparatus 10 ends the processing. On the other hand, when a foreign object region is detected in the processing in S11 (Yes in S12), the warning unit 13 determines whether the size of the detected foreign object region is equal to or greater than a reference value (S13). For example, the warning unit 13 determines a reference value, based on the information illustrated in FIG. 6 or FIG. 7, the information for identifying the camera generating the acquired captured image, and the position of the detected foreign object region in the captured image. Then, the warning unit 13 determines whether the size of the detected foreign object region is equal to or greater than the determined reference value.

When the detected foreign object regions include a foreign object region with a size equal to or greater than the reference value (Yes in S13), the warning unit 13 executes the warning processing. Details of the warning processing are as described above, and therefore description thereof is omitted here. On the other hand, when the detected foreign object regions do not include a foreign object region with a size equal to or greater than the reference value (No in S13), the processing apparatus 10 ends the processing.

Next, advantageous effects of the processing apparatus 10 according to the present example embodiment are described. The processing apparatus 10 that can detect a foreign object region in a managed object included in a captured image enables automatic detection of a foreign object existing in the managed object by image analysis. Then, the processing apparatus 10 performs the warning processing when the size of the detected foreign object region is equal to or greater than a reference value and does not perform the warning processing when the size of the detected foreign object region is less than the reference value and therefore can avoid a warning against a negligible foreign object not affecting store operation and an erroneous warning based on noise of image data not being a foreign object to begin with.

Further, the processing apparatus 10 can set the aforementioned reference value for each camera or each position in a captured image and therefore can set a suitable reference value for each managed object or each predetermined area in a managed object (for example, for each display area in a product display shelf) according to, for example, a required level of cleanliness. As a result, the processing apparatus 10 can avoid inconvenience of increasing a workload of a worker (such as checking/removal work of a foreign object) due to unnecessary issuance of many warnings while suitably detecting and removing a foreign object.

Further, a reference value can be set for each camera or each position in a captured image according to the direction of the camera, the distance between the camera and a subject, and the like, and therefore a foreign object larger than a desired size can be very precisely detected regardless of the direction of the camera and the distance between the camera and the subject.

Further, a specified color can be specified, and a region in a color different from the specified color can be detected as a foreign object region, and therefore a computer load for the processing of detecting a foreign object region can be relatively lightened.

Further, an approved object can be preset, and a region in which the approved object does not exist can be detected as a foreign object region, and therefore inconvenience of detecting an object existence of which in a managed object is not a problem as a foreign object can be avoided.

### Second Example Embodiment

Specifics of processing of detecting a foreign object region by a foreign object region detection unit 12 in a processing apparatus 10 according to the present example embodiment differ from those according to the first example embodiment.

Specifically, the foreign object region detection unit 12 detects a region in which an object exists in a managed object included in a captured image, based on a known object detection technology. Subsequently, the foreign object region detection unit 12 determines whether an approved object exists in the region in which an object exists. Specifically, the foreign object region detection unit 12 determines whether the detected object is the approved object, based on features of appearances of the detected object and the approved object. The determination is achieved by a technique similar to “the determination of whether an approved object exists in a region in a color different from a specified color” described in the first example embodiment. Then, the foreign object region detection unit 12 detects a region (region in which an object exists) in which the approved object is not determined to exist as a foreign object region. On the other hand, the foreign object region detection unit 12 does not detect a region (region in which an object exists) in which the approved object is determined to exist as a foreign object region.

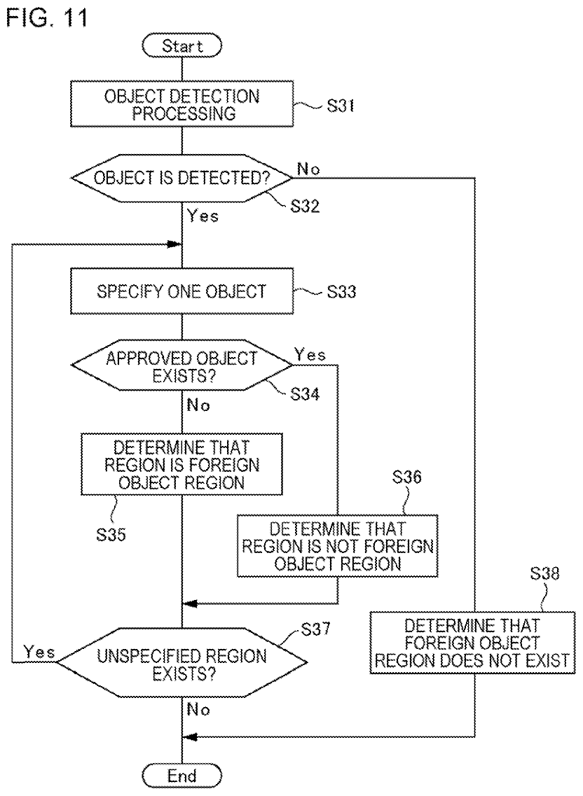

Next, an example of a flow of processing in the processing apparatus 10 is described by using flowcharts in FIG. 9 and FIG. 11.

When an acquisition unit 11 acquires a captured image, the processing illustrated in FIG. 9 is executed. The processing illustrated in FIG. 9 is as described in the first example embodiment, and therefore description thereof is omitted here.

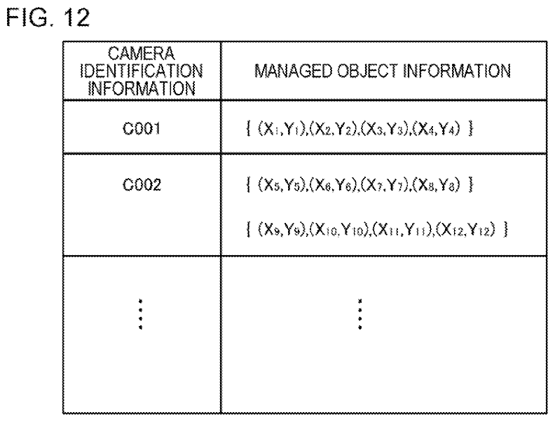

FIG. 11 illustrates an example of a flow of processing of detecting a foreign object region in S11. First, the foreign object region detection unit 12 performs processing of detecting an object in a managed object included in a captured image, based on any object detection technology (S31). For example, the foreign object region detection unit 12 determines a managed object in an acquired captured image, based on the information illustrated in FIG. 12 and information for identifying a camera generating the captured image. Then, the foreign object region detection unit 12 detects an object in the determined managed object, based on any object detection technology.

When an object is not detected (No in S32), the foreign object region detection unit 12 determines that a foreign object region does not exist (S38).

On the other hand, when an object is detected (Yes in S32), the foreign object region detection unit 12 specifies one object out of the detected objects (S33). Then, the foreign object region detection unit 12 determines whether an approved object exists in a region in which the specified object exists (S34). For example, the foreign object region detection unit 12 determines an approved object related to the specified object, based on the information illustrated in FIG. 5, information for identifying a camera generating the acquired captured image, and the position of the region in which the specified object exists in the captured image. Then, the foreign object region detection unit 12 determines whether the approved object exists in the region in which the specified object exists by using a technique using the aforementioned estimation model, template matching, or the like.

When determining that the approved object exists (Yes in S34), the foreign object region detection unit 12 determines that the region in which the specified object exists is not a foreign object region (S36). On the other hand, when determining that the approved object does not exist (No in S34), the foreign object region detection unit 12 determines that the region in which the specified object exists is a foreign object region (S35).

Then, when a region not being specified in S33 remains (Yes in S37), the foreign object region detection unit 12 returns to S33 and repeats similar processing.

The remaining configuration of the processing apparatus 10 is similar to that according to the first example embodiment.

Next, advantageous effects of the processing apparatus 10 according to the present example embodiment are described. The processing apparatus 10 according to the present example embodiment achieves advantageous effects similar to those achieved by the processing apparatus 10 according to the first example embodiment. Further, advance registration of a specified color and the like is unnecessary, and therefore a processing load is lightened accordingly.

Note that “acquisition” herein may include “an apparatus getting data stored in another apparatus or a storage medium (active acquisition)” in accordance with a user input or an instruction of a program, such as reception by making a request or an inquiry to another apparatus, and readout by accessing another apparatus or a storage medium. Further, “acquisition” may include “an apparatus inputting data output from another apparatus to the apparatus (passive acquisition)” in accordance with a user input or an instruction of a program, such as reception of distributed (or, for example, transmitted or push notified) data. Further, “acquisition” may include acquisition by selection from received data or information and “generating new data by data editing (such as conversion to text, data sorting, partial data extraction, or file format change) or the like and acquiring the new data.”

While the present invention has been described with reference to example embodiments (and examples), the present invention is not limited to the aforementioned example embodiments (and examples). Various changes and modifications that may be understood by a person skilled in the art may be made to the configurations and details of the present invention without departing from the scope of the present invention.

### REFERENCE SIGNS LIST

1A Processor
2A Memory
3A Input-output I/F
4A Peripheral circuit
5A Bus
10 Processing apparatus
11 Acquisition unit
12 Foreign object region detection unit
13 Warning unit
100 Shelf board
101 Product
102 Border
103 Foreign object region

1. A processing apparatus comprising:
at least one memory configured to store one or more instructions; and
at least one processor configured to execute the one or more instructions to:
acquire a captured image including a managed object related to a store;
detect a foreign object region in the managed object included in the captured image, wherein the color of the foreign object region is different from a specified color; and
output warning of the foreign object region detected.

2. The processing apparatus according to claim 1, wherein the processor is further configured to execute the one or more instructions to:
determine whether an approved object exists in a region in a color different from the specified color; and wherein
the foreign object region detected is the region which the approved object is determined not to exist.

3. The processing apparatus according to claim 1, wherein the specified color is set for each region included in the captured image.

4. The processing apparatus according to claim 1, wherein the specified color is specified by an RGB value or a range of RGB values.

5. The processing apparatus according to claim 1, wherein the processor is further configured to execute the one or more instructions to:
output the captured image in which the foreign object region detected is highlighted as the warning.

6. The processing apparatus according to claim 1, wherein the processor is further configured to execute the one or more instructions to:
store information of the foreign object region detected; and
output, at a predetermined timing, the information stored as the warning.

7. The processing apparatus according to claim 1, wherein the processor is further configured to execute the one or more instructions to:
output, comparable with the captured image, a previous image in which the foreign object region does not exist, wherein the previous image is captured before the captured image.

8. The processing apparatus according to claim 1, wherein the processor is further configured to execute the one or more instructions to:
output instruction to remove a foreign object.

9. A processing method comprising:
by a computer,
acquiring a captured image including a managed object related to a store;
detecting a foreign object region in the managed object included in the captured image, wherein the color of the foreign object region is different from a specified color; and
outputting warning of the foreign object region detected.

10. The processing method according to claim 9,
wherein the computer determines whether an approved object exists in a region in a color different from the specified color; and
wherein the foreign object region detected is the region which the approved object is determined not to exist.

11. The processing method according to claim 9, wherein the specified color is set for each region included in the captured image.

12. The processing method according to claim 9, wherein the specified color is specified by an RGB value or a range of RGB values.

13. The processing method according to claim 9,
wherein the computer outputs the captured image in which the foreign object region detected is highlighted as the warning.

14. The processing method according to claim 9, wherein the computer:
stores information of the foreign object region detected; and
outputs, at a predetermined timing, the information stored as the warning.

15. A non-transitory storage medium storing a program causing a computer to:
acquire a captured image including a managed object related to a store;
detect a foreign object region in the managed object included in the captured image, wherein the color of the foreign object region is different from a specified color; and
output warning of the foreign object region detected.

16. The non-transitory storage medium according to claim 15,
wherein the program causing the computer to determine whether an approved object exists in a region in a color different from the specified color; and
wherein the foreign object region detected is the region which the approved object is determined not to exist.

17. The non-transitory storage medium according to claim 15, wherein the specified color is set for each region included in the captured image.

18. The non-transitory storage medium according to claim 15, wherein the specified color is specified by an RGB value or a range of RGB values.

19. The non-transitory storage medium according to claim 15,
wherein the program causing the computer to output the captured image in which the foreign object region detected is highlighted as the warning.

20. The non-transitory storage medium according to claim 15, wherein the program causing the computer to:
store information of the foreign object region detected; and
output, at a predetermined timing, the information stored as the warning.
